(19) United States
(12) Patent Application Publication
(10) Pub. No.: US 2025/0338360 A1
(43) Pub. Date: Oct. 30, 2025

(54) SYSTEMS, METHODS, AND DEVICES FOR SURFACE RESISTIVITY AND SOLAR TRANSMISSION OPTIMIZATION FOR DEICING AND DEFOGGING

(71) Applicant: Betterfrost Technologies Inc., Oakville (CA)

(72) Inventors: Sameh M. I. Saad, Stoney Creek (CA); Ahmed Sheir, Brampton (CA); Derrick Redding, Ann Arbor, MI (US)

(21) Appl. No.: 19/188,503

(22) Filed: Apr. 24, 2025

Related U.S. Application Data
(60) Provisional application No. 63/637,971, filed on Apr. 24, 2024.

(51) Int. Cl. H05B 3/86; G01D 5/24; G01K 7/18

(52) U.S. Cl. CPC H05B 3/86; G01D 5/2405; G01K 7/183

(57) ABSTRACT

Systems, methods, and devices for resistivity and solar transmitting optimization of surfaces for de-icing and defogging are provided. The multi-layered system for deicing and defogging of surfaces comprises a high reflectivity, low-emissivity (Low-E) coating aimed at controlling solar heat gain; and a higher resistance coating having a resistance higher than the high reflectivity, low-emissivity (Low-E) coating, the higher resistance coating configured to receive electricity for generating heat to facilitate deicing and defogging.

### TECHNICAL FIELD

The following relates generally to systems, methods, and devices for surface deicing and defogging, and more particularly to multi-layered coatings for optimization of surface resistivity and solar heat gain control for deicing and defogging.

### INTRODUCTION

Surfaces such as windshields in automobiles are susceptible to ice formation when exposed to freezing temperatures. When the temperature of the environment falls below the freezing point, this moisture freezes upon contact with the cold surface, leading to a formation of frost, slush, or ice. Also, in certain conditions, the inner surface of the windshield fogs up. The presence of such accumulations on windshields and mirrors may impair a driver's or passenger's view, creating a critical safety hazard. Ice can also hinder the mechanical operation of windshield wipers, potentially causing damage to the wiper blades or their motor systems.

To overcome this issue, various techniques have been implemented to remove ice from such surfaces. Among these, electric heating systems integrated within windshields are particularly effective for deicing and defogging. These systems typically utilize transparent electrically conductive coatings or thin wire elements embedded in the glass that heat up as electrical current passes through them. The electrical connections for these elements are often made via busbars, and their operation may be controlled by switches or processors designed to regulate the power flow.

The electric surface deicing and defogging systems operate on the principle of resistive heating and leverage the conductive properties of the coatings or films. The coatings applied to windshields have preferred resistivities that create resistance to the electrical current flowing through them, thereby generating heat. Commonly employed materials include Indium Tin Oxide (ITO), Fluorine-doped Tin Oxide (FTO), carbon nanotubes (CNTs), and silver, known for their effective resistive and conductive properties.

A key aspect of optimizing electric windshield heating systems is the adjustment of the resistivity levels of these conductive materials or elements. The chosen level of resistivity affects how much electrical power is resisted by the elements, which in turn determines the amount of heat produced. This heat is crucial for melting layers of frost or ice that cover the windshield and other automotive glass surfaces.

Elements or coatings with too low resistivity might not generate sufficient heat to melt significant ice accumulations and could draw excessive current from the vehicle's electrical system. This not only risks overloading the system but also poses safety threats, especially if the low-resistivity elements are exposed to touch. For instance, while Triple Silver MSVD (Magnetron Sputter Vacuum Deposition) coatings are useful for reducing UV light transmission, their low resistivity is not ideal for heating applications in electric deicing systems due to reduced heating efficiency. This inefficiency can compromise the system's effectiveness in critical conditions.

Additionally, windshields and other transparent surfaces aim for lower total solar transmission (TTS) to mitigate solar heat gain, preventing discomfort and excessive interior heat in vehicles or indoor spaces. TTS indicates the percentage of total solar radiant heat energy that enters through the glass. Low-E coatings are used on windshields and other transparent surfaces for enhancing energy efficiency by controlling the thermal and optical properties of glass. These coatings are thin, metallic layers applied to glass that minimize the transmission of ultraviolet and infrared light while preserving high levels of visible light transmission. This selective transmission is useful for reducing solar heat gain without compromising the brightness and clarity of the glass. By reflecting a significant portion of the incoming solar radiation, these coatings help maintain cooler cabin temperatures, thus reducing the reliance on air conditioning systems and enhancing passenger comfort.

Traditionally, silver (Ag) based coatings, including those employing triple-layered silver (Ag3) configurations or Ag2 or Ag4, are favored for their reflective properties and low sheet resistance, typically below 1-3 ohms per square. The silver (Ag) based low-emissivity (Low-E) coatings provide a total solar transmission (TTS) value of 40% approximately for the triple-layered silver. Despite their efficacy in reducing heat, the low resistivity of these coatings limits their utility in other applications, such as electrical heating for deicing or defogging purposes.

For electric deicing, defrosting, and defogging systems integrated into windshields, a higher electrical resistance of the surfaces is intended. Coatings with higher electrical resistance allow for better control over the distribution and application of electrical heat generated across the glass surface. Coatings with higher resistivities, such as those made from Indium Tin Oxide (ITO), Fluorine-doped Tin Oxide (FTO), or Carbon Nanotubes (CNT), typically offer resistances over 10 ohms per square, making them suitable for these purposes. However, these materials have higher total solar transmission (TTS) values, allowing greater solar heat transmission, thus potentially compromising the heat-shielding benefits provided by low-E coatings.

Therefore, there exists a need for a coating system that harmoniously integrates the benefits of low resistivity and high resistivity materials to ensure efficient performance of the electric deicing and defogging systems, while maintain high solar and IR reflexivity of Low-E coatings.

Accordingly, systems, methods, and devices are desired that overcome one or more disadvantages associated with existing surfaces, including windshields and transparent surfaces, and particularly towards optimizing the resistivity of the surface deicing and defogging systems while maintaining solar reflectivity.

### SUMMARY

A multi-layered system for deicing and defogging of surfaces is provided. The system comprises a high reflectivity, low-emissivity (Low-E) coating aimed at controlling solar heat gain and a higher resistance coating having a resistance higher than the high reflectivity, low-emissivity (Low-E) coating, the higher resistance coating configured to receive electricity for generating heat to facilitate deicing and defogging.

In an embodiment, the higher resistance coating has a resistance between 10 ohms/sq to 60 ohms/sq.

In an embodiment, the high reflectivity coating has a total solar transmission (TTS) between 35% to 50%.

In an embodiment, the high reflectivity coating has a resistance between 0.5 ohms/sq to 5 ohms/sq.

In an embodiment, the higher resistance coating comprises a conductive transparent material selected from the group consisting of Indium Tin Oxide (ITO), Fluorine-doped Tin Oxide (FTO), carbon nanotubes (CNTs) or other similar materials.

In an embodiment, the high reflectivity coating comprises a silver-based coating including either one of Ag2, Ag3, or Ag4 or other silver-based compounds.

In an embodiment, the low-emissivity (Low-E) coating is connected with two busbars to measure the electrical resistance changes for detecting surface temperature.

In an embodiment, the higher resistance coating includes ablated tracks to lengthen the distance of current flow for increasing coating resistance.

In an embodiment, an electric charge is applied to the low-emissivity (Low-E) coating and the higher resistance coating to measure impedance changes for proximity detection.

In an embodiment, proximity detection includes dielectric permittivity detection.

A method for manufacturing a multi-layered system for deicing and defogging of transparent surfaces is provided. The method comprises applying a high reflectivity, low-emissivity (Low-E) coating onto a surface facing the exterior environment, the high reflectivity, low-emissivity (Low-E) coating configured to control solar heat gain; and applying a higher resistance coating adjacent to the high reflectivity, low-emissivity (Low-E) coating, the higher resistance coating having a resistance higher than the high reflectivity, low-emissivity (Low-E) coating, the higher resistance coating configured to receive electricity for generating heat to facilitate deicing and defogging.

In an embodiment, the higher resistance coating has a resistance between 10 ohms/sq to 60 ohms/sq.

In an embodiment, the high reflectivity coating has a total solar transmission (TTS) between 35% to 50%.

In an embodiment, the high reflectivity coating has a resistance between 0.5 ohms/sq to 5 ohms/sq.

In an embodiment, the higher resistance coating comprises a conductive transparent material selected from the group consisting of Indium Tin Oxide (ITO), Fluorine-doped Tin Oxide (FTO), carbon nanotubes (CNTs) or other similar materials.

In an embodiment, the high reflectivity coating comprises a silver-based coating including either one of Ag2, Ag3, or Ag4 or other silver-based compounds.

In an embodiment, the method further comprises connecting the low-emissivity (Low-E) coating with two busbars to measure the electrical resistance changes for detecting surface temperature.

In an embodiment, the method further comprises providing ablated tracks to the higher resistance coating to lengthen the distance of current flow for increasing coating resistance.

In an embodiment, the method further comprises applying an electric charge to the low-emissivity (Low-E) coating and the higher resistance coating to measure impedance changes for proximity detection.

In an embodiment, proximity detection includes dielectric permittivity detection.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of systems, methods, and devices of the present specification. In the drawings:

FIG. 1 shows a block diagram illustrating a system in the prior art for deicing and defogging the exposed surfaces, according to an embodiment.

FIG. 2 shows a simplified block diagram of a processing device for surface deicing and defogging, according to an embodiment.

FIG. 3 shows a cross-sectional view of multi-coated system 300 with high reflexivity low-emissivity coating and a higher resistance coating, according to an embodiment.

FIG. 4 shows a cross-sectional view of multi-coated system 400 with a higher resistance coating and a high reflexivity low-emissivity coating, according to an embodiment.

FIG. 5 shows a cross-sectional view of multi-coated system 500 with a higher resistance coating and a high reflexivity low-emissivity coating, according to an embodiment.

FIG. 6 shows a cross-sectional view of multi-coated system 600 with a higher resistance coating and a high reflexivity low-emissivity coating, according to an embodiment.

FIG. 7 is a flow chart of a method of manufacturing the multi-coated system with a higher resistance coating and a high reflexivity low-emissivity coating, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

A description of an embodiment with several components in connection with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of more than one device or article.

While the present apparatus and processes have been described with reference to particular embodiments, it should be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

In this regard, the scope of the present apparatus and processes is not limited to the specific embodiments disclosed herein. Other variations, modifications, and alternatives are also within the scope of the present apparatus and processes. The appended claims are intended to cover such variations, modifications, and alternatives as fall within their true spirit and scope.

Additionally, the present disclosure is not limited to the described methods, systems, devices, and apparatuses, but includes variations, modifications, and other uses thereof as come within the scope of the appended claims. The detailed description of the embodiments and the drawings are illustrative and not restrictive.

For this application, de-icing includes melting, at least a section, of the accumulated ice on the exposed surface. Similarly, defogging or demisting includes the removal, at least one section, of the fog or mist layer on the glass surface. In an embodiment, the operations described for de-icing or defogging include surface heating.

The following relates generally to systems, methods, and devices for surface deicing and defogging, and more particularly to multi-layered coatings for optimization of surface resistivity and solar heat gain control for deicing and defogging.

Low-emissivity (Low-E) glass provides a variety of benefits when used in vehicle windshields and windows, including thermal and energy efficiency to prevent heat from escaping or entering the vehicles. Low-emissivity (Low-E) glass includes a coat of a thin layer of metal or metallic oxide, which reflects thermal radiation and inhibits thermal emission, reducing heat transfer. Surfaces using low-emissivity (Low-E) glass provide temperature regulation by reflecting the radiant heat from the sun, thereby keeping the inner temperature cooler. In cold temperatures, low-emissivity (Low-E) glass reduces the heat escaping from the interior, thereby keeping the inner temperature cooler. Further, Low-emissivity (Low-E) glass is beneficial in preventing transmission of harmful ultraviolet (UV) rays and infrared light without compromising the among of visible light, thereby protecting passengers and the interior of the vehicle from UV damage. Overall, the low-emissivity (Low-E) glass improves temperature regulation and energy efficiency and reduces the consumption of resources for heating and cooling the inner conditions of the vehicle. For similar properties of reflecting ultraviolet and infrared light, Low-E glass is also used in building windows and doors.

Low-E glass includes low-emissivity coatings that reflect ultraviolet rays and infrared energy. Processes such as pyrolytic or hard coating methods and Magnetron Sputter Vacuum Deposition (MSVD) may be used for applying low-emissivity coatings. When used in windshield glass, the low emissivity coating may be applied on either the glass surface facing the interior of the vehicle, or the surface facing the exterior of the vehicle. In an embodiment, the low emissivity coating is applied at the interface between a glass layer and the Polyvinyl Butyral (PVB) interlayer used in the windshields. Commonly used materials in low emissivity coatings include Pyrolytic, Double Silver Magnetron Sputter Vacuum Deposition (MSVD), and Triple Silver Magnetron Sputter Vacuum Deposition (MSVD).

Electric windshield deicing systems work on the principle of resistive heating, where an electric current is passed through a transparent electro-conductive coating in the windshield glass. The resistive heating is caused due to passage of the electric current, leading to the melting, of at least a section of the ice accumulation on the exterior windshield surface. Electric windshield defogging systems operate on a similar principle, where the transparent electro-conductive coating in the windshield is applied close to the glass layer exposed to the interior of the vehicle. The heat generated due to resistive heating at the inner glass layer increases the glass surface temperature above the dew point and hence defogs the surface.

However, if the coatings provide low resistivity and or possess low resistive heating properties, a significantly higher electric current is required to generate the heat necessary to melt the accumulated ice or defog the inner glass surface. This may result in increased energy demand and additional strain on the vehicle's electrical system. When applied to an electric vehicle, this may reduce the vehicle's overall range. Further, potential safety concerns may arise as the low resistivity and high current may cause short circuits. Additionally, if the conductive coating is exposed due to a crack or damage to the windshield, it may potentially pose an electrical hazard for humans who may touch the coating accidentally.

The coatings used in Low-E glass, including Double Silver Magnetron Sputter Vacuum Deposition (MSVD), or a Triple Silver Magnetron Sputter Vacuum Deposition (MSVD), while providing electro-conductive properties, also exhibit low resistivity making them difficult to use with electric windshield deicing and defogging systems.

Therefore, optimization of resistivity of the low-emissivity (Low-E) glass or similar surfaces with coatings possessing low resistivity properties improves deicing and defogging functions when used with electric deicing and defogging systems. Further, the resistive heating elements may need to be evenly applied for uniform heating for deicing and defogging operations. Therefore, designing a low-emissivity (Low-E) glass windshield and glass panes with an integrated deicing and defogging system balances heat reflectivity, uniform electrical conductivity, energy efficiency, and safety.

The present disclosure relates to a multi-layered coating system designed for use on surfaces such as building window glass panes, automotive glass, such as windshields, to facilitate deicing, defogging, and solar heat management while maintaining high levels of visible light transmission. These coatings may be applied on both the exterior and interior surfaces of the glass, encompassing a Polyvinyl Butyral (PVB) interlayer commonly used in safety glass configurations for its impact resistance and adhesion properties. In an embodiment, one or more layers or coatings designed to reflect infrared radiation and reduce solar heat gain (low-emissivity or “Low-E” properties) may be applied at the exterior-facing surface of the glass or between the exterior-facing surface and the PVB layer. In an embodiment, one or more layers or coatings designed with higher electrical resistance suitable for resistive heating applications for deicing and defogging, may be applied at the interior-facing surface of the glass or between the interior-facing surface and the PVB layer.

The high reflexivity, low-e coatings minimize the emission of infrared radiation to reduce heat transfer through the coated screens or glass. In an embodiment, the low-emissivity coatings provide a resistance between 0.5 ohms/sq to 5 ohms/sq. Materials such as metal oxides (e.g., tin oxide, indium tin oxide) or metallic layers (e.g., silver, gold) are commonly used in Low-E coatings. Examples of low-e coatings include Ag2, Ag3, and Ag4.

In an embodiment, the high electrical resistance coatings provide a resistance between 10 ohms/sq to 30 ohms/sq. The higher electrical resistance coatings may include materials such as Indium Tin Oxide (ITO) or Carbon Nanotubes (CNT) or Fluorine doped Tin Oxide (FTO).

In an embodiment, a multi-layered coating system is provided. The system may include a high reflexivity coating applied closer to the exterior surface to optimally reflect infrared radiation, thereby reducing the Total Solar Transmission (TTS). The high reflexivity, low sheet resistance coating may include triple-layered silver (Ag3) coating or Ag2 or Ag4. Another layer or coating with materials having higher resistance, may be applied closer to the interior surface. The higher electrical resistance coatings may include materials such as Indium Tin Oxide (ITO) or Carbon Nanotubes (CNT) or Fluorine doped Tin Oxide (FTO). This higher resistance coating or layer's higher resistivity provides for efficiently generating heat when an electrical current is applied to the higher resistance coating or layer. The heat may provide for the rapid melting of ice or prevention of fog formation on the glass surface. The arrangement of these coatings, including the possibility of additional layers, may be varied based on specific performance requirements or manufacturing considerations.

Furthermore, the present disclosure is not confined to any particular arrangement of these coatings with respect to the PVB layer. While preferred embodiments include layers with high reflexivity and Low-E properties, and another distinct layer with high electrical resistance (greater than the reflective layers), these may be configured in various sequences on either or both sides of the PVB layer. The flexibility in the design allows for the adaptation of the coating system to optimize both visibility through the glass and the efficacy of the thermal and optical properties required for specific environmental conditions. As such, two or more layers of different coatings may be used as required to achieve the desired balance of properties, enhancing both safety and comfort for vehicle occupants.

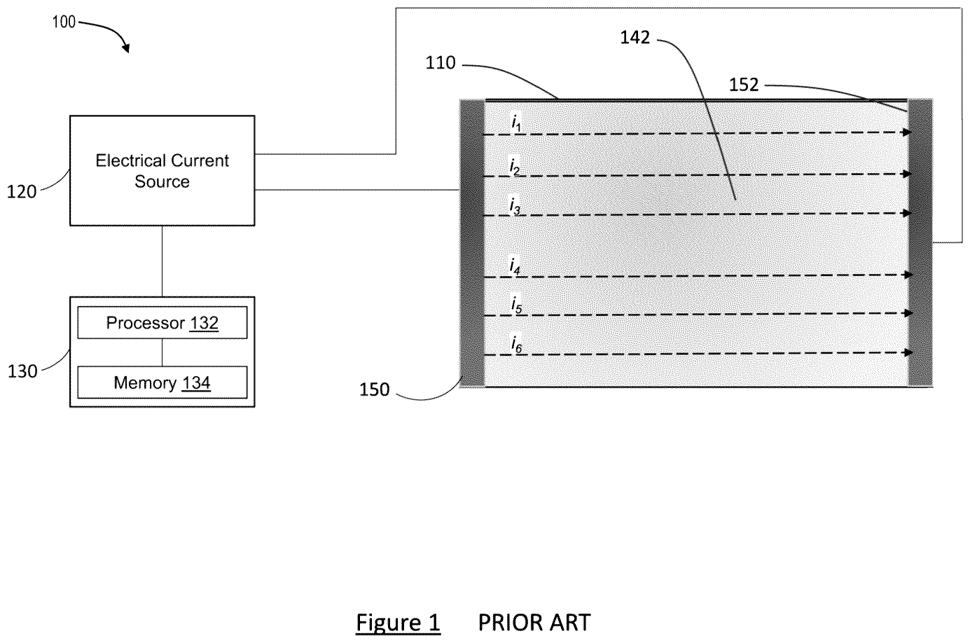

FIG. 1 shows a block diagram illustrating a system 100 in the prior art for deicing and defogging the exposed surfaces.

The system is configured to remove ice from the surface 110. The surface 110 may include vehicle windshields, rear vehicle windows, aircraft windshields, and glass or similar material used in buildings.

The system includes an electrical current source 120. The electrical current source 120 may be connected to a vehicle battery.

The electrical current source 120 is further connected to a processing unit 130. The processing unit includes a processor 132 and memory 134.

The surface 110 includes a transparent electro-conductive coating 142. The connectors 150 and 152 create a potential difference leading to the current flow as indicated in i₁ to i₆. The electrical current source 120 may provide pulsed electrothermal deicing (PETD) current to the connectors 150 and 152, resulting in flow of electric current and generation of resistive heating to the surface 110 for de-icing. In an embodiment, the electrical current source includes a direct current (DC). Other forms of electric current provided by the electrical current source includes alternating current (AC) for conveniently stepping up or reducing the voltage power. In an embodiment, the electrical current source includes a plurality of current types, with application of a direct current (DC) first. The preferred resistance properties in heating track 140 ranges between 1 ohm and 100 ohms per square foot.

The system may include an impedance meter (not shown) to provide a capacitance level based on the phase difference between the AC excitation signal provided by the AC excitation source (not shown) and the induced current. Impedance may be taken to include resistance, capacitance, inductance, and any combination of the foregoing. The memory 134 may also store de-icing conditions based on the capacitance level or the impedance level corresponding to the detected thickness of the ice accumulation. When the ice accumulation exceeds a threshold thickness, the de-icing condition may be satisfied and the processor 132 may execute instructions to activate the electric current source 120 for providing the electric current to the heating track 140 for deicing. The electric current source 120 may be deactivated when the ice accumulation and thickness fall below the threshold thickness corresponding to the de-icing conditions.

The system may also include a temperature sensor (not shown) connected to the surface 110 and the processor 132. The temperature sensor may detect the temperature of the surface to at least partly determine whether de-icing conditions are present, and the nature and amount of the ice accumulation. When the ice accumulation exceeds a temperature threshold, the de-icing condition may be satisfied and the processor 132 may execute instructions to activate the electric current source 120 for providing the electric current to the heating track 140 for deicing. The electric current source 120 may be deactivated when the ice accumulation and temperature fall below the temperature threshold corresponding to the de-icing conditions.

The system may also detect the dielectric permittivity of the accumulation on the surface to detect whether the accumulation includes water, ice, or snow. As a result, the corresponding electric current level may be released by the electric current source 120 to remove the accumulation on surface 110.

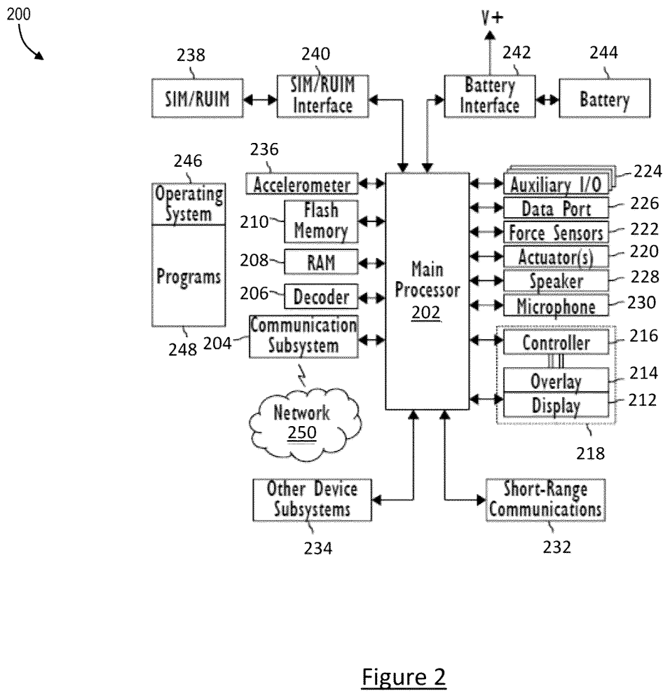

FIG. 2 shows a simplified block diagram of components of a processing device 200 for surface deicing and defogging connected to the windshield with optimized resistivity, according to an embodiment.

The device 200 includes a processor 202 that controls the operations of the device 200. Communication functions, including data communications, voice communications, or both may be performed through a communication subsystem 204. The communication subsystem 204 may receive messages from, and send messages to, a wireless network 250. Data received by the device 200 may be decompressed and decrypted by a decoder 206.

The wireless network 250 may be any type of wireless network, including, but not limited to, data-centric wireless networks, voice-centric wireless networks, and dual-mode networks that support both voice and data communications.

The device 200 may be a battery-powered device and as shown includes a battery interface 242 for connecting one or more rechargeable batteries 244.

The processor 202 also interacts with additional subsystems such as a Random Access Memory (RAM) 208, a flash memory 210, a display 212 (e.g. with a touch-sensitive overlay 214 connected to an electronic controller 216 that together comprise a touch-sensitive display 218), an actuator assembly 220, one or more optional force sensors 222, an auxiliary input/output (I/O) subsystem 224, a data port 226, a speaker 228, a microphone 230, short-range communications systems 232 and other device subsystems 234.

In some embodiments, user-interaction with the graphical user interface may be performed through the touch-sensitive overlay 214. The processor 202 may interact with the touch-sensitive overlay 214 via the electronic controller 216. Information, such as text, characters, symbols, images, icons, and other items that may be displayed or rendered on a portable electronic device generated by the processor 202 may be displayed on the touch-sensitive display 218.

The processor 202 may also interact with an accelerometer 236 as shown in FIG. 2. The accelerometer 236 may be utilized for detecting direction of gravitational forces or gravity-induced reaction forces. The processor 202 is configured to interact with the heating elements and icing detector units described herein.

To identify a subscriber for network access according to the present embodiment, the device 200 may use a Subscriber Identity Module or a Removable User Identity Module (SIM/RUIM) card 238 inserted into a SIM/RUIM interface 240 for communication with a network (such as the wireless network 250). Alternatively, user identification information may be programmed into the flash memory 210 or performed using other techniques.

The device 200 also includes an operating system 246 and software components 248 that are executed by the processor 202 and which may be stored in a persistent data storage device such as the flash memory 210. Additional applications may be loaded onto the device 200 through the wireless network 250, the auxiliary I/O subsystem 224, the data port 226, the short-range communications subsystem 232, or any other suitable device subsystem 234.

For example, in use, a received signal such as a text message, an e-mail message, web page download, or other data may be processed by the communication subsystem 204 and input to the processor 202. The processor 202 then processes the received signal for output to the display 212 or alternatively to the auxiliary I/O subsystem 224. A subscriber may also compose data items, such as e-mail messages, for example, which may be transmitted over the wireless network 250 through the communication subsystem 204.

For voice communications, the overall operation of the device 200 may be similar. The speaker 228 may output audible information converted from electrical signals, and the microphone 230 may convert audible information into electrical signals for processing.

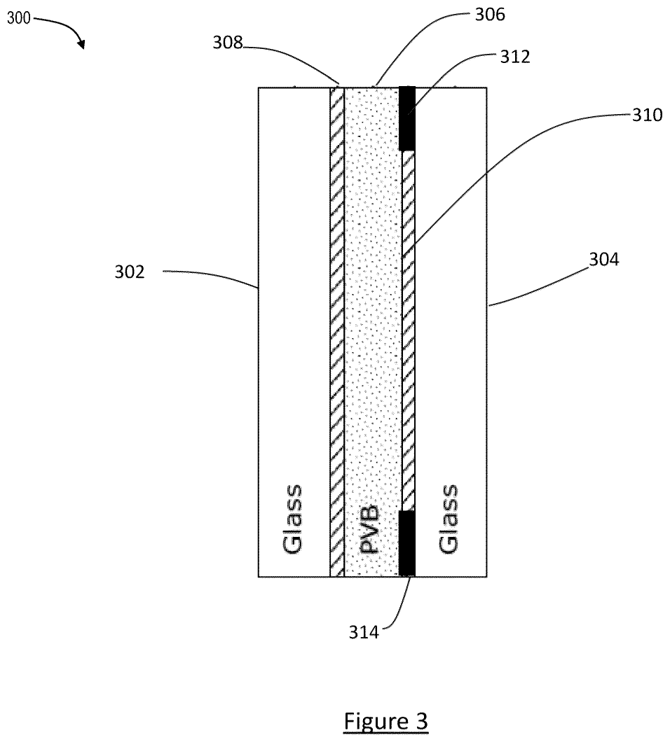

FIG. 3 shows a cross-sectional view of multi-coated system 300 with high reflexivity low-emissivity coating and a higher resistance coating, according to an embodiment.

The system 300 may refer to vehicle windshields, rear windows, door handles or other surfaces, vehicles including automobiles, electric vehicles, trains, and maritime vehicles; aircraft windshields, wings, rotors; building windows; outdoor equipment such as security cameras, lighting fixtures, electronic billboards, traffic signals; and evaporator coils in refrigeration and air conditioning systems. In the embodiment of FIG. 3, the system 300 is a windshield.

The present disclosure provides a multi-coated system 300. This system 300 integrates a combination of a high reflexivity low-emissivity (Low-E) coating and a higher resistance coating to optimize thermal and optical properties. This present disclosure provides a silver-based coating with low resistivity and high reflexivity at one of the layers within the system 300 and a coating with higher resistance, on another layer within the system 300. By implementing these coatings on different layers of the windshield, the combined total solar transmission (TTS) is maintained close to a preferred range, ensuring effective solar heat gain control without compromising visibility. The preferred range of TTS for the combined system with the multiple coatings is 35% to 50%. Additionally, the combination of coatings also provide for a high resistance layer suitable for electric deicing and defogging solutions.

The system 300 includes surface 302, which may face the exterior environment. The surface 302 may be composed of glass material. The surface 302 may be susceptible to various environmental effects such as solar radiation and precipitation. The surface 304 may face the interior of the vehicle, and may interface with the cabin and its occupants for a windshield system 300. The surface 304 may be composed of glass material. Centrally located within the glass assembly is a Polyvinyl Butyral (PVB) layer 306, which traditionally provides impact resistance and adhesion between the glass layers. However, alternative materials or the omission of this layer 306 is also contemplated within different embodiments.

In the embodiment of FIG. 3, a high reflexivity and low resistance layer 308 facing the outer surface 302 is positioned adjacent to the PVB layer 306 and towards the outer surface 302. Further, in the same embodiment, a high resistance layer 310 facing the inner surface 304 is positioned adjacent to the PVB layer 306 and towards the inner surface 304.

In an embodiment, the layer 308 in the cross-section is positioned between the outer glass and the PVB layer 306. The layer 308 includes a coating of low resistivity and high reflective capabilities against infrared (IR) and radiation. The terms “layer” and “coating” may be used interchangeably. In an embodiment, the layer 308 is a silver 3 coated layer (Ag3) or Ag2 or Ag4. The coating of layer 308 provides for reducing IR and solar heat gain inside the vehicle, thus maintaining a cooler cabin environment and reducing the load on air conditioning systems. The layer is preferably transparent to preserve driver or indoor occupant visibility. The coated layer 308 also provides for reflecting solar energy while allowing visible light to pass through. The coating may be applied across the entire surface of the system 300 or selectively based on specific needs. The coating is integrated into the glass assembly as either a thin film or a more substantial coating depending on the application requirements.

The high reflexivity Low-E coatings minimize the emission of infrared radiation to reduce heat transfer through the coated screens or glass. In an embodiment, the low-emissivity coatings provide a resistance between 0.5 ohms/sq to 5 ohms/sq. Materials such as metal oxides (e.g., tin oxide, indium tin oxide) or metallic layers (e.g., silver, gold) are commonly used in Low-E coatings. Examples of low-e coatings include Ag2, Ag3, and Ag4.

According to an embodiment, the layer facing the outer surface 302 or the layer facing the inner surface 304 is configured to operate as a temperature sensor by incorporating two busbars (not shown). For example, the low-emissivity (Low-E) layer 308 is connected to two busbars, which are strategically positioned along the edges of the Low-E layer. The busbars are configured to measure the electrical resistance changes that correlate with temperature fluctuations. Since the electrical properties of the coating material (such as silver or other metallic films) vary with temperature, the resistance across the busbars may provide a real-time measure of the surface temperature of the surface such as the windscreen glass. The busbars may be connected to a processor (now shown) to compute the surface temperature by correlating change in resistance with real-time temperature value. By monitoring the resistance, the deicing or defogging system may detect and respond to the formation of ice or excessive heat, adjusting the heating elements in the high resistance layer automatically to maintain optimal visibility and safety. This feature improves the functionality of the deicing system and provides energy efficiency by activating the heating elements, when necessary, based on real-time temperature readings.

In an embodiment, the layer 310 in the cross-section is positioned between the inner glass surface and the PVB layer 306. The layer 310 includes a coating of materials with higher electrical resistance compared to the coating of the layer 308. The terms “layer” and “coating” may be used interchangeably. The coating of layer 310 provides for deicing and defogging functions through resistive heating. When electrical power is applied to the layer 310, the resistance offered by the layer 310 generates heat. The heat may effectively melt ice or reduce condensation accumulation on the surface of the windshield 300. The layer 310 is preferably transparent to ensure it does not impede visibility and is applied as either a coating or a film.

In an embodiment, the high electrical resistance coatings provide a resistance between 10 ohms/sq to 60 ohms/sq. The higher electrical resistance coatings may include materials such as Indium Tin Oxide (ITO) or Carbon Nanotubes (CNT) or Fluorine doped Tin Oxide (FTO).

In an embodiment, connectors 312 and 314 are connected to windshield 300 to apply the electric current to the layer or coating 310. In an embodiment, the connectors 312 and 314 are connected to the coating 310 through respective busbars (not shown). In an embodiment, a first busbar (not shown) is placed at the windshield 300 and connected to electric source (not shown) through the first connector 312, also referred as an inlet connector. The first busbar may be composed of either a metallic aluminum or copper strip or silver paste. In an embodiment, the inlet connector 312 and the connector 314, also referred to as outlet connector, are placed at any locations on the windshield 300 to create an electrical current path within the coating 310.

In an embodiment, the electric current is supplied to the coating 310 by the inlet connector 312. In an embodiment, the electric current is supplied to the coating 310 by the first busbar (not shown). The inlet connector 312 is electrically connected to an electrical current source (not shown). The electrical current source may include a vehicle's battery. In an embodiment, the inlet connector 312 or the first busbar receives electrical current from the electrical current source and distributes the electrical current into the windshield 300 through the coating 310. As the electrical power traverses through the conductive material of the coating 310, heat is generated due to the resistivity of the coating 310. The heat results in the deicing of, at least a section, of the accumulated ice on the windshield 300. In an embodiment, similar application of heat on the surface results in defogging of, at least a section of, the fog collected on the windshield 300. The electric circuit with the windshield is completed at the outlet connector 314. Alternatively, the electric current may be received by a second busbar (not shown) connected to the outlet connector 314. The electric current path within the windshield 300 begins at the inlet connector 312 and exits the windshield 300 at the outlet connector 314. The electric current returns to the power source through the second busbar or outlet connector 314 to complete the circuit.

In an embodiment, the electric current is supplied to the coating 310 by the inlet connector 312 directly without a first busbar. In an embodiment, the electric current exits the coating 310 through the outlet connector 314 without a second busbar. In an embodiment, the connectors 312 and 314 include a respective connecting means to electrically connect the electrical current source to the coating 310. Examples of connectors include one or more of conductive clips, spring-loaded connectors, busbars, tab connectors, or wires. In an embodiment, the connectors 312 and 314 are connected to the electrical current source through an electrically conductive means such as a wire.

According to an embodiment, the electrical current source provides pulsed electrothermal deicing (PETD) current to the connectors 312 and 314 to provide heat to the coating 310 for de-icing. In an embodiment, an alternative electrical current receiving unit is utilized instead of the busbars. In an embodiment, the electrical current source provides constant electric current at any frequency. In an embodiment, the electrical current source provides electric current at a plurality of frequencies, including a high frequency current.

The present disclosure is not limited to any specific arrangement of these coatings or layers 308 and 310 with respect to each other or the PVB layer. The coatings may be interchanged or combined in various configurations on either side of the PVB to achieve the desired properties of high reflexivity, low emissivity, and sufficient electrical resistance for heating purposes. This flexibility in design allows the system 300 to be configured to specific environmental conditions or performance requirements. Whether employing two or more layers of coatings, the system may be adapted to provide optimal visibility, heat management, and electrical heating efficiency, thereby enhancing the safety and comfort of vehicle occupants.

Examples of high resistance coating in the multi-layered system include conductive transparent materials such as Indium Tin Oxide (ITO), Fluorine-doped Tin Oxide (FTO), and Carbon Nanotubes (CNTs). Alternatively, the high resistance coatings may be selected from materials that offer higher electrical resistance, approximately around 10 ohms/sq, for efficient heating applications while maintaining transparency across the surface.

According to an embodiment, the high resistance coating 310 is modified with use of ablated tracks (not shown) to control electric current flow. The introduction of ablated tracks includes deliberately removing sections of the electro-conductive coating from the surface 310, effectively providing the path and distribution of electricity across the coating. The coating sections may be removed by laser etching. In certain embodiments, the high resistance coating is entirely removed at the ablated tracks to create breaks in conductivity, thereby inhibiting the direct flow of electricity through these sections. Alternatively, the ablation might be designed as incomplete cuts within the coating 310, allowing current to flow around or close to the edges of these tracks, thereby completing the circuit through the remaining connected sections of the coating. The modification directs the current to follow a more complex path, often in an “S” shape or other configurations, which increases the distance the current travels. By extending the travel distance of the electric current within the coating, these ablated tracks effectively increase the overall resistance of the system. Moreover, varying the shape and number of these ablated tracks allows for precise tuning of the resistance properties, enhancing the heating efficiency and energy distribution across the surfaces such as the windshield.

Materials for high reflectivity coating employed in the system are selected based on the total solar transmission (TTS) ratings. The preferred range of TTS for the combined system with the multiple coatings is 35% to 50%. The high reflectivity coating provides enhanced reflectivity against solar radiation and infrared (IR) heat, contributing to effective solar heat gain control. The high reflectivity coating may exhibit a lower resistance, approximately ranging from 0.5 to 3 ohms/sq. An example of high reflectivity coating includes a silver-based layer such as Silver 3 (Ag3).

According to an embodiment, the dual coating configuration within the windshield provides for proximity sensing of external objects such as, for example, surface ice accumulation, and environmental conditions like rain, snow, or frost. A small electrical charge may be applied on the layers 308 and 310 and the impedance changes may be measured using a processor (not shown). Impedance may be taken to include resistance, capacitance, inductance, and any combination of the foregoing. The change in impedance is attributed to the presence of external objects close to the glass surface. The variations in impedance occur due to changes in the dielectric constant of the environment surrounding the windshield, such as the proximity of objects or the accumulation of environmental elements like rain or snow. The sensing feature may be used to provide automatic climate control responses to changes in weather conditions.

The combination of the high resistance coating and the high reflectivity coating not only facilitates efficient deicing and defogging functions but also ensures compliance with regulatory standards governing automotive glass coatings. One such standard mandates include that the glass must maintain a visible light transmission (Tvis) rating of over 70%. This requirement ensures that the glass remains transparent enough to preserve driver visibility, regardless of the embedded technological enhancements aimed at enhancing functionality. Thus, the integrated coatings not only optimize thermal and optical properties but also provide the transparency required for safe driving conditions in accordance with regulatory mandates.

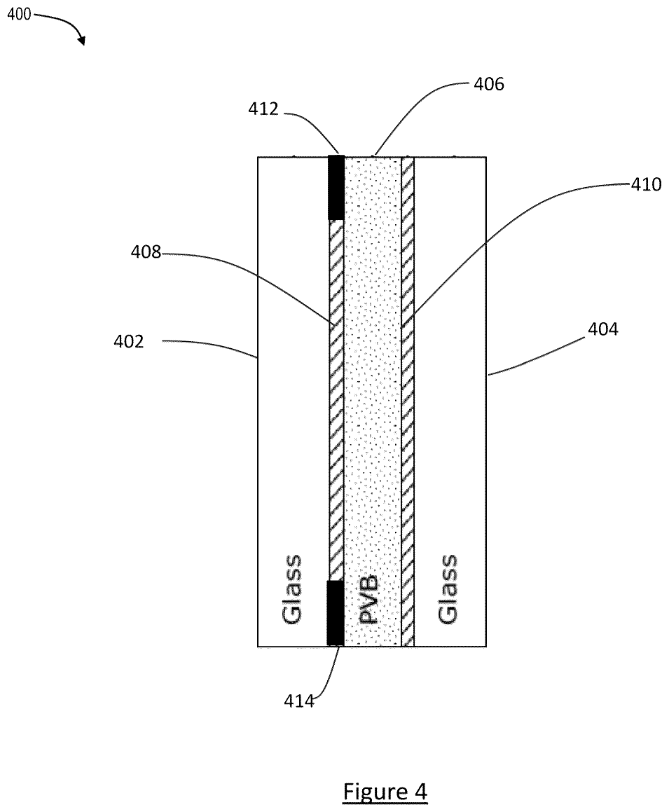

FIG. 4 shows a cross-sectional view of multi-coated system 400 with a higher resistance coating and a high reflexivity low-emissivity coating, according to an embodiment.

The system 400 may refer to vehicle windshields, rear windows, door handles or other surfaces, vehicles including automobiles, electric vehicles, trains, and maritime vehicles; aircraft windshields, wings, rotors; building windows; outdoor equipment such as security cameras, lighting fixtures, electronic billboards, traffic signals; and evaporator coils in refrigeration and air conditioning systems. In the embodiment of FIG. 4, the system 400 is a windshield.

The present disclosure provides a multi-coated system 400. This system 400 integrates a combination of a high reflexivity low-emissivity (Low-E) coating and a higher resistance coating to optimize thermal and optical properties. This present disclosure provides a silver-based coating with low resistivity and high reflexivity at one of the layers within the system 400 and a coating with higher resistance, on another layer within the system 400. By implementing these coatings on different layers of the windshield, the combined total solar transmission (TTS) is maintained close to a preferred range, ensuring effective solar heat gain control without compromising visibility. The preferred range of TTS for the combined system with the multiple coatings is 35% to 50%. Additionally, the combination of coatings also provide for a high resistance layer suitable for electric deicing and defogging solutions.

The system 400 includes surface 402, which may face the exterior environment. The surface 402 may be composed of glass material. The surface 402 may be susceptible to various environmental effects such as solar radiation and precipitation. The surface 404 may face the interior of the vehicle, and may interface with the cabin and its occupants for a windshield system 400. The surface 404 may be composed of glass material. Centrally located within the glass assembly is a Polyvinyl Butyral (PVB) layer 406, which traditionally provides impact resistance and adhesion between the glass layers. However, alternative materials or the omission of this layer 406 is also contemplated within different embodiments.

In the embodiment of FIG. 4, a high resistance layer 408 facing the outer surface 402 is positioned adjacent to the PVB layer 406 and towards the outer surface 402. Further, in the same embodiment, a high reflexivity and low resistance layer 410 facing the inner surface 404 is positioned adjacent to the PVB layer 406 and towards the inner surface 404.

In an embodiment, the layer 410 in the cross-section is positioned between the inner glass 404 and the PVB layer 406. The layer 410 includes a coating of low resistivity and high reflective capabilities against infrared (IR) and radiation. The terms “layer” and “coating” may be used interchangeably. In an embodiment, the layer 410 is a silver 3 coated layer (Ag3) or Ag2 or Ag4. The coating of layer 410 provides for reducing IR and solar heat gain inside the vehicle, thus maintaining a cooler cabin environment and reducing the load on air conditioning systems. The layer is preferably transparent to preserve driver or indoor occupant visibility. The coated layer 410 also provides for reflecting solar energy while allowing visible light to pass through. The coating may be applied across the entire surface of the system 400 or selectively based on specific needs. The coating is integrated into the glass assembly as either a thin film or a more substantial coating depending on the application requirements.

The high reflexivity Low-E coatings minimize the emission of infrared radiation to reduce heat transfer through the coated screens or glass. In an embodiment, the low-emissivity coatings provide a resistance between 0.5 ohms/sq to 5 ohms/sq. Materials such as metal oxides (e.g., tin oxide, indium tin oxide) or metallic layers (e.g., silver, gold) are commonly used in Low-E coatings. Examples of low-e coatings include Ag2, Ag3, and Ag4.

In an embodiment, the layer 408 in the cross-section is positioned between the outer glass surface 402 and the PVB layer 406. The layer 408 includes a coating of materials with higher electrical resistance compared to the coating of the layer 410. The terms “layer” and “coating” may be used interchangeably. The coating of layer 408 provides for deicing and defogging functions through resistive heating. When electrical power is applied to the layer 408, the resistance offered by the layer 408 generates heat. The heat may effectively melt ice or reduce condensation accumulation on the surface of the windshield 300. The layer 408 is preferably transparent to ensure it does not impede visibility and is applied as either a coating or a film.

In an embodiment, the high electrical resistance coatings provide a resistance between 10 ohms/sq to 60 ohms/sq. The higher electrical resistance coatings may include materials such as Indium Tin Oxide (ITO) or Carbon Nanotubes (CNT) or Fluorine doped Tin Oxide (FTO).

In an embodiment, connectors 412 and 414 are connected to windshield 400 to apply the electric current to the layer or coating 408. In an embodiment, the connectors 412 and 414 are connected to the coating 408 through respective busbars (not shown). In an embodiment, a first busbar (not shown) is placed at the windshield 400 and connected to electric source (not shown) through the first connector 412, also referred as an inlet connector. The first busbar may be composed of either a metallic aluminum or copper strip or silver paste. In an embodiment, the inlet connector 412 and the connector 414, also referred to as outlet connector, are placed at any locations on the windshield 400 to create an electrical current path within the coating 408.

In an embodiment, the electric current is supplied to the coating 408 by the inlet connector 412. In an embodiment, the electric current is supplied to the coating 408 by the first busbar (not shown). The inlet connector 412 is electrically connected to an electrical current source (not shown). The electrical current source may include a vehicle's battery. In an embodiment, the inlet connector 412 or the first busbar receives electrical current from the electrical current source and distributes the electrical current into the windshield 400 through the coating 408. As the electrical power traverses through the conductive material of the coating 408, heat is generated due to the resistivity of the coating 408. The heat results in the deicing of, at least a section, of the accumulated ice on the windshield 400. In an embodiment, similar application of heat on the surface results in defogging of, at least a section of, the fog collected on the windshield 400. The electric circuit with the windshield is completed at the outlet connector 414. Alternatively, the electric current may be received by a second busbar (not shown) connected to the outlet connector 414. The electric current path within the windshield 400 begins at the inlet connector 412 and exits the windshield 400 at the outlet connector 414. The electric current returns to the power source through the second busbar or outlet connector 414 to complete the circuit.

In an embodiment, the electric current is supplied to the coating 408 by the inlet connector 412 directly without a first busbar. In an embodiment, the electric current exits the coating 408 through the outlet connector 414 without a second busbar. In an embodiment, the connectors 412 and 414 include a respective connecting means to electrically connect the electrical current source to the coating 408. Examples of connectors include one or more of conductive clips, spring-loaded connectors, busbars, tab connectors, or wires. In an embodiment, the connectors 412 and 414 are connected to the electrical current source through an electrically conductive means such as a wire.

According to an embodiment, the electrical current source provides pulsed electrothermal deicing (PETD) current to the connectors 412 and 414 to provide heat to the coating electrical current source for de-icing. In an embodiment, an alternative electrical current receiving unit is utilized instead of the busbars. In an embodiment, the electrical current source provides constant electric current at any frequency. In an embodiment, the electrical current source provides electric current at a plurality of frequencies, including a high frequency current.

The present disclosure is not limited to any specific arrangement of these coatings or layers 408 and 410 with respect to each other or the PVB layer. The coatings may be interchanged or combined in various configurations on either side of the PVB to achieve the desired properties of high reflexivity, low emissivity, and sufficient electrical resistance for heating purposes. This flexibility in design allows the system 400 to be configured to specific environmental conditions or performance requirements. Whether employing two or more layers of coatings, the system may be adapted to provide optimal visibility, heat management, and electrical heating efficiency, thereby enhancing the safety and comfort of vehicle occupants.

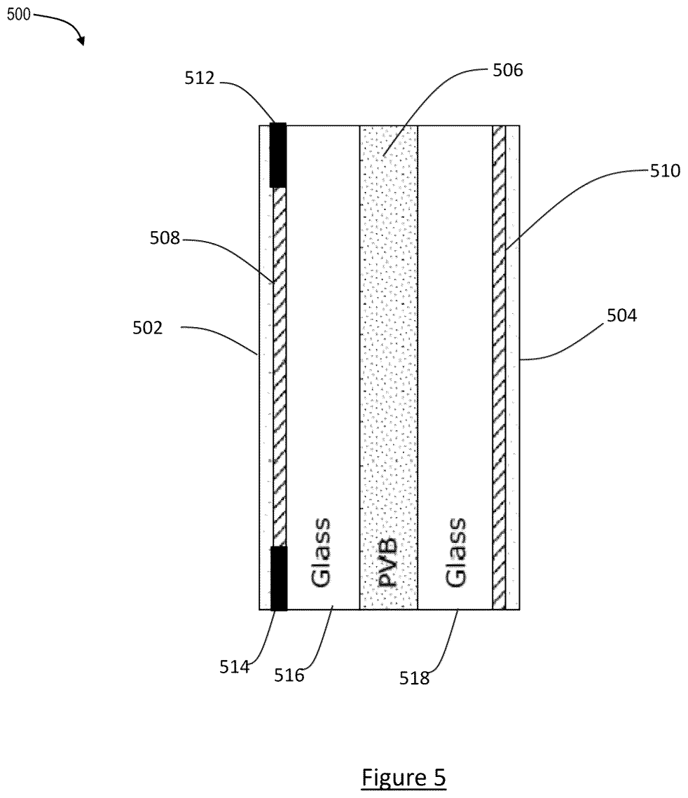

FIG. 5 shows a cross-sectional view of multi-coated system 500 with a higher resistance coating and a high reflexivity low-emissivity coating, according to an embodiment.

The system 500 may refer to vehicle windshields, rear windows, door handles or other surfaces, vehicles including automobiles, electric vehicles, trains, and maritime vehicles; aircraft windshields, wings, rotors; building windows; outdoor equipment such as security cameras, lighting fixtures, electronic billboards, traffic signals; and evaporator coils in refrigeration and air conditioning systems. In the embodiment of FIG. 5, the system 500 is a windshield.

The present disclosure provides a multi-coated system 500. This system 400 integrates a combination of a high reflexivity low-emissivity (Low-E) coating and a higher resistance coating to optimize thermal and optical properties. This present disclosure provides a silver-based coating with low resistivity and high reflexivity at one of the layers within the system 500 and a coating with higher resistance, on another layer within the system 500. By implementing these coatings on different layers of the windshield, the combined total solar transmission (TTS) is maintained close to a preferred range, ensuring effective solar heat gain control without compromising visibility. The preferred range of TTS for the combined system with the multiple coatings is 35% to 50%. Additionally, the combination of coatings also provide for a high resistance layer suitable for electric deicing and defogging solutions.

The system 500 includes surface 502, which may face the exterior environment. The surface 502 may be composed of glass material. The surface 502 may be susceptible to various environmental effects such as solar radiation and precipitation. The surface 504 may face the interior of the vehicle, and may interface with the cabin and its occupants for a windshield system 500. The surface 504 may be composed of glass material. Centrally located within the glass assembly is a Polyvinyl Butyral (PVB) layer 506, which traditionally provides impact resistance and adhesion between the glass layers. However, alternative materials or the omission of this layer 506 is also contemplated within different embodiments.

In the embodiment of FIG. 5, a high resistance layer 508 facing the outer surface 502 is spaced apart from the PVB layer 506, where a material layer 516 is placed between the high resistance layer 508 and the PVB layer 506. The material layer 516 may be composed of glass material. Further, in the same embodiment, a high reflexivity and low resistance layer 510 facing the inner surface 504 is spaced apart from the PVB layer 506, where a material layer 518 is placed between the high reflexivity and low resistance layer 510 and the PVB layer 506. The material layer 518 may be composed of glass material.

In an embodiment, the layer 510 in the cross-section is positioned between the inner glass surface 504 and the material layer 518. The layer 510 includes a coating of low resistivity and high reflective capabilities against infrared (IR) and radiation. The terms “layer” and “coating” may be used interchangeably. In an embodiment, the layer 510 is a silver 3 coated layer (Ag3) or Ag2 or Ag4. The coating of layer 510 provides for reducing IR and solar heat gain inside the vehicle, thus maintaining a cooler cabin environment and reducing the load on air conditioning systems. The layer is preferably transparent to preserve driver or indoor occupant visibility. The coated layer 510 also provides for reflecting solar energy while allowing visible light to pass through. The coating may be applied across the entire surface of the system 500 or selectively based on specific needs. The coating is integrated into the glass assembly as either a thin film or a more substantial coating depending on the application requirements.

The high reflexivity Low-E coatings minimize the emission of infrared radiation to reduce heat transfer through the coated screens or glass. In an embodiment, the low-emissivity coatings provide a resistance between 0.5 ohms/sq to 5 ohms/sq. Materials such as metal oxides (e.g., tin oxide, indium tin oxide) or metallic layers (e.g., silver, gold) are commonly used in Low-E coatings. Examples of low-e coatings include Ag2, Ag3, and Ag4.

In an embodiment, the layer 508 in the cross-section is positioned between the outer glass surface 502 and the material layer 516. The layer 508 includes a coating of materials with higher electrical resistance compared to the coating of the layer 510. The terms “layer” and “coating” may be used interchangeably. The coating of layer 508 provides for deicing and defogging functions through resistive heating. When electrical power is applied to the layer 508, the resistance offered by the layer 508 generates heat. The heat may effectively melt ice or reduce condensation accumulation on the surface of the windshield 300. The layer 508 is preferably transparent to ensure it does not impede visibility and is applied as either a coating or a film.

In an embodiment, the high electrical resistance coatings provide a resistance between 10 ohms/sq to 60 ohms/sq. The higher electrical resistance coatings may include materials such as Indium Tin Oxide (ITO) or Carbon Nanotubes (CNT) or Fluorine doped Tin Oxide (FTO).

In an embodiment, connectors 512 and 514 are connected to windshield 500 to apply the electric current to the layer or coating 508. In an embodiment, the connectors 512 and 514 are connected to the coating 508 through respective busbars (not shown). In an embodiment, a first busbar (not shown) is placed at the windshield 500 and connected to electric source (not shown) through the first connector 512, also referred as an inlet connector. The first busbar may be composed of either a metallic aluminum or copper strip or silver paste. In an embodiment, the inlet connector 512 and the connector 514, also referred to as outlet connector, are placed at any locations on the windshield 500 to create an electrical current path within the coating 508.

In an embodiment, the electric current is supplied to the coating 508 by the inlet connector 512. In an embodiment, the electric current is supplied to the coating 508 by the first busbar (not shown). The inlet connector 512 is electrically connected to an electrical current source (not shown). The electrical current source may include a vehicle's battery. In an embodiment, the inlet connector 512 or the first busbar receives electrical current from the electrical current source and distributes the electrical current into the windshield 500 through the coating 508. As the electrical power traverses through the conductive material of the coating 508, heat is generated due to the resistivity of the coating 508. The heat results in the deicing of, at least a section, of the accumulated ice on the windshield 500. In an embodiment, similar application of heat on the surface results in defogging of, at least a section of, the fog collected on the windshield 500. The electric circuit with the windshield is completed at the outlet connector 514. Alternatively, the electric current may be received by a second busbar (not shown) connected to the outlet connector 514. The electric current path within the windshield 500 begins at the inlet connector 512 and exits the windshield 500 at the outlet connector 514. The electric current returns to the power source through the second busbar or outlet connector 514 to complete the circuit.

In an embodiment, the electric current is supplied to the coating 508 by the inlet connector 512 directly without a first busbar. In an embodiment, the electric current exits the coating 508 through the outlet connector 514 without a second busbar. In an embodiment, the connectors 512 and 514 include a respective connecting means to electrically connect the electrical current source to the coating 508. Examples of connectors include one or more of conductive clips, spring-loaded connectors, busbars, tab connectors, or wires. In an embodiment, the connectors 512 and 514 are connected to the electrical current source through an electrically conductive means such as a wire.

According to an embodiment, the electrical current source provides pulsed electrothermal deicing (PETD) current to the connectors 512 and 514 to provide heat to the coating electrical current source for de-icing. In an embodiment, an alternative electrical current receiving unit is utilized instead of the busbars. In an embodiment, the electrical current source provides constant electric current at any frequency. In an embodiment, the electrical current source provides electric current at a plurality of frequencies, including a high frequency current.

The present disclosure is not limited to any specific arrangement of these coatings or layers 508 and 510 with respect to each other or the PVB layer. The coatings may be interchanged or combined in various configurations on either side of the PVB to achieve the desired properties of high reflexivity, low emissivity, and sufficient electrical resistance for heating purposes. This flexibility in design allows the system 500 to be configured to specific environmental conditions or performance requirements. Whether employing two or more layers of coatings, the system may be adapted to provide optimal visibility, heat management, and electrical heating efficiency, thereby enhancing the safety and comfort of vehicle occupants.

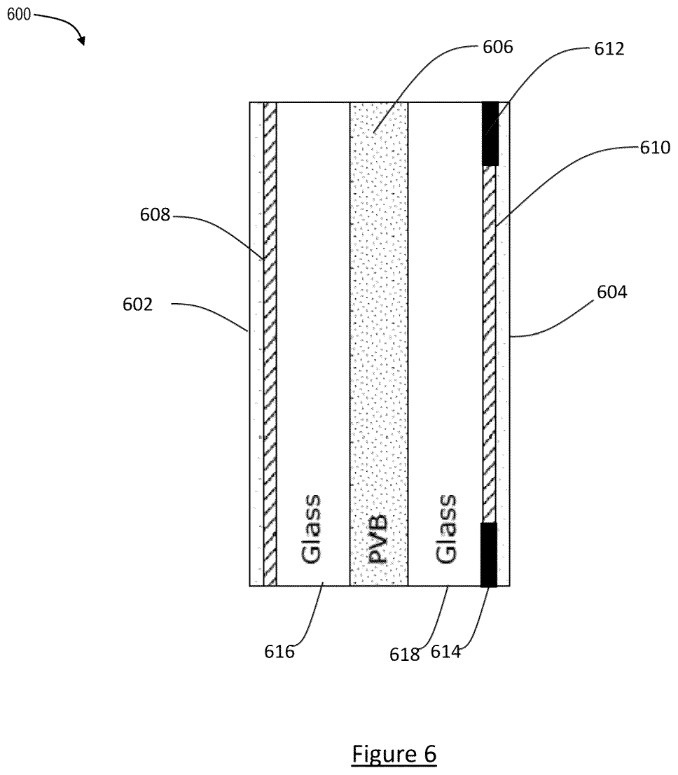

FIG. 6 shows a cross-sectional view of multi-coated system 600 with a higher resistance coating and a high reflexivity low-emissivity coating, according to an embodiment.

The system 600 may refer to vehicle windshields, rear windows, door handles or other surfaces, vehicles including automobiles, electric vehicles, trains, and maritime vehicles; aircraft windshields, wings, rotors; building windows; outdoor equipment such as security cameras, lighting fixtures, electronic billboards, traffic signals; and evaporator coils in refrigeration and air conditioning systems. In the embodiment of FIG. 6, the system 600 is a windshield.

The present disclosure provides a multi-coated system 600. This system 600 integrates a combination of a high reflexivity low-emissivity (Low-E) coating and a higher resistance coating to optimize thermal and optical properties. This present disclosure provides a silver-based coating with low resistivity and high reflexivity at one of the layers within the system 600 and a coating with higher resistance, on another layer within the system 600. By implementing these coatings on different layers of the windshield, the combined total solar transmission (TTS) is maintained close to a preferred range, ensuring effective solar heat gain control without compromising visibility. The preferred range of TTS for the combined system with the multiple coatings is 35% to 50%. Additionally, the combination of coatings also provide for a high resistance layer suitable for electric deicing and defogging solutions.

The system 600 includes surface 602, which may face the exterior environment. The surface 602 may be composed of glass material. The surface 602 may be susceptible to various environmental effects such as solar radiation and precipitation. The surface 604 may face the interior of the vehicle, and may interface with the cabin and its occupants for a windshield system 600. The surface 604 may be composed of glass material. Centrally located within the glass assembly is a Polyvinyl Butyral (PVB) layer 606, which traditionally provides impact resistance and adhesion between the glass layers. However, alternative materials or the omission of this layer 606 is also contemplated within different embodiments.

In the embodiment of FIG. 6, a high reflexivity and low resistance layer 608 facing the outer surface 602 is spaced apart from the PVB layer 606, where a material layer 616 is placed between the high reflexivity and low resistance layer 608 and the PVB layer 606. The material layer 616 may be composed of glass material. Further, in the same embodiment, a high resistance layer 610 facing the inner surface 604 is spaced apart from the PVB layer 606, where a material layer 618 is placed between the high resistance layer 610 and the PVB layer 606. The material layer 618 may be composed of glass material.

In an embodiment, the layer 608 in the cross-section is positioned between the outer glass surface 602 and the material layer 616. The layer 608 includes a coating of low resistivity and high reflective capabilities against infrared (IR) and radiation. The terms “layer” and “coating” may be used interchangeably. In an embodiment, the layer 608 is a silver 3 coated layer (Ag3) or Ag2 or Ag4. The coating of layer 608 provides for reducing IR and solar heat gain inside the vehicle, thus maintaining a cooler cabin environment and reducing the load on air conditioning systems. The layer is preferably transparent to preserve driver or indoor occupant visibility. The coated layer 608 also provides for reflecting solar energy while allowing visible light to pass through. The coating may be applied across the entire surface of the system 600 or selectively based on specific needs. The coating is integrated into the glass assembly as either a thin film or a more substantial coating depending on the application requirements.

The high reflexivity Low-E coatings minimize the emission of infrared radiation to reduce heat transfer through the coated screens or glass. In an embodiment, the low-emissivity coatings provide a resistance between 0.5 ohms/sq to 5 ohms/sq. Materials such as metal oxides (e.g., tin oxide, indium tin oxide) or metallic layers (e.g., silver, gold) are commonly used in Low-E coatings. Examples of low-e coatings include Ag2, Ag3, and Ag4.

In an embodiment, the layer 610 in the cross-section is positioned between the inner glass surface 604 and the material layer 618. The layer 610 includes a coating of materials with higher electrical resistance compared to the coating of the layer 610. The terms “layer” and “coating” may be used interchangeably. The coating of layer 610 provides for deicing and defogging functions through resistive heating. When electrical power is applied to the layer 610, the resistance offered by the layer 610 generates heat. The heat may effectively melt ice or reduce condensation accumulation on the surface of the windshield. The layer 610 is preferably transparent to ensure it does not impede visibility and is applied as either a coating or a film.

In an embodiment, the high electrical resistance coatings provide a resistance between 10 ohms/sq to 60 ohms/sq. The higher electrical resistance coatings may include materials such as Indium Tin Oxide (ITO) or Carbon Nanotubes (CNT) or Fluorine doped Tin Oxide (FTO).

In an embodiment, connectors 612 and 614 are connected to windshield 600 to apply the electric current to the layer or coating 610. In an embodiment, the connectors 612 and 614 are connected to the coating 610 through respective busbars (not shown). In an embodiment, a first busbar (not shown) is placed at the windshield 600 and connected to electric source (not shown) through the first connector 612, also referred as an inlet connector. The first busbar may be composed of either a metallic aluminum or copper strip or silver paste. In an embodiment, the inlet connector 612 and the connector 614, also referred to as outlet connector, are placed at any locations on the windshield 600 to create an electrical current path within the coating 608.

In an embodiment, the electric current is supplied to the coating 610 by the inlet connector 612. In an embodiment, the electric current is supplied to the coating 610 by the first busbar (not shown). The inlet connector 612 is electrically connected to an electrical current source (not shown). The electrical current source may include a vehicle's battery. In an embodiment, the inlet connector 612 or the first busbar receives electrical current from the electrical current source and distributes the electrical current into the windshield 600 through the coating 610. As the electrical power traverses through the conductive material of the coating 610, heat is generated due to the resistivity of the coating 610. The heat results in the deicing of, at least a section, of the accumulated ice on the windshield 600. In an embodiment, similar application of heat on the surface results in defogging of, at least a section of, the fog collected on the windshield 600. The electric circuit with the windshield is completed at the outlet connector 614. Alternatively, the electric current may be received by a second busbar (not shown) connected to the outlet connector 614. The electric current path within the windshield 600 begins at the inlet connector 612 and exits the windshield 600 at the outlet connector 614. The electric current returns to the power source through the second busbar or outlet connector 614 to complete the circuit.

In an embodiment, the electric current is supplied to the coating 610 by the inlet connector 612 directly without a first busbar. In an embodiment, the electric current exits the coating 610 through the outlet connector 614 without a second busbar. In an embodiment, the connectors 612 and 614 include a respective connecting means to electrically connect the electrical current source to the coating 610. Examples of connectors include one or more of conductive clips, spring-loaded connectors, busbars, tab connectors, or wires. In an embodiment, the connectors 612 and 614 are connected to the electrical current source through an electrically conductive means such as a wire.

According to an embodiment, the electrical current source provides pulsed electrothermal deicing (PETD) current to the connectors 612 and 614 to provide heat to the coating electrical current source for de-icing. In an embodiment, an alternative electrical current receiving unit is utilized instead of the busbars. In an embodiment, the electrical current source provides constant electric current at any frequency. In an embodiment, the electrical current source provides electric current at a plurality of frequencies, including a high frequency current.

The present disclosure is not limited to any specific arrangement of these coatings or layers 608 and 610 with respect to each other or the PVB layer. The coatings may be interchanged or combined in various configurations on either side of the PVB to achieve the desired properties of high reflexivity, low emissivity, and sufficient electrical resistance for heating purposes. This flexibility in design allows the system 600 to be configured to specific environmental conditions or performance requirements. Whether employing two or more layers of coatings, the system may be adapted to provide optimal visibility, heat management, and electrical heating efficiency, thereby enhancing the safety and comfort of vehicle occupants.

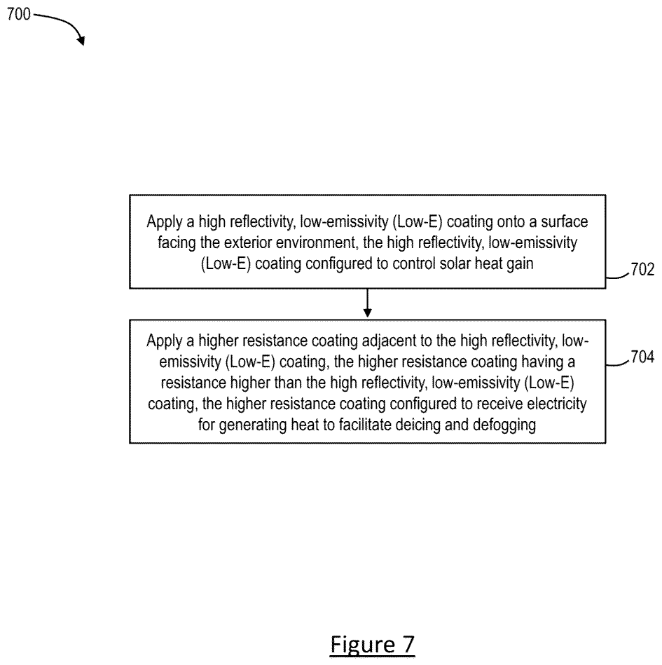

FIG. 7 is a flow chart of a method of manufacturing the multi-coated system with a higher resistance coating and a high reflexivity low-emissivity coating, according to an embodiment.

At 702, the method includes applying a high reflectivity, Low-E coating onto a surface facing the exterior environment. The high reflectivity coating is positioned to optimize solar heat gain control and visibility maintenance.

At 704, the method includes applying a higher resistance coating, characterized by higher electrical resistance compared to the high reflectivity, Low-E coating. The higher resistance coating is applied adjacent to the previously applied high reflectivity layer. The configuration provides that the higher resistance coating may efficiently receive electricity for the purpose of generating heat required to facilitate deicing and defogging functions.

The present disclosure provides a method for manufacturing a multi-coated system. This method 700 integrates a combination of a high reflexivity low-emissivity (Low-E) coating and a higher resistance coating to optimize thermal and optical properties. This present disclosure provides a silver-based coating with low resistivity and high reflexivity at one of the layers and a coating with higher resistance, on another layer. By implementing these coatings on different layers of the windshield, the combined total solar transmission (TTS) is maintained close to a preferred range, ensuring effective solar heat gain control without compromising visibility. The preferred range of TTS for the combined system with the multiple coatings is 35% to 50%. Additionally, the combination of coatings also provides for a high resistance layer suitable for electric deicing and defogging solutions.

While the above description provides examples of one or more apparatus, methods, or systems, it will be appreciated that other apparatus, methods, or systems may be within the scope of the claims as interpreted by one of skill in the art. Elements of each embodiment may be incorporated into other embodiments, for example, configurations discussed in relation to one embodiment, may be applied to other embodiments disclosed herein. Further, it is evident that various modifications and combinations can be made without departing from the invention. The specification and drawings are, accordingly, to be regarded simply as an illustration of the invention as defined by the claims, and are contemplated to cover any and all modifications, variations, combinations or equivalents that fall within the scope of the present invention.

1. A multi-layered system for deicing and defogging of surfaces, comprising:
a high reflectivity, low-emissivity (Low-E) coating aimed at controlling solar heat gain; and
a higher resistance coating having a resistance higher than the high reflectivity, low-emissivity (Low-E) coating, the higher resistance coating configured to receive electricity for generating heat to facilitate deicing and defogging.

2. The system of claim 1, wherein the higher resistance coating has a resistance between 10 ohms/sq to 60 ohms/sq.

3. The system of claim 1, wherein the high reflectivity coating has a total solar transmission (TTS) between 35% to 50%.

4. The system of claim 1, wherein the high reflectivity coating has a resistance between 0.5 ohms/sq to 5 ohms/sq.

5. The system of claim 1, wherein the higher resistance coating comprises a conductive transparent material selected from the group consisting of Indium Tin Oxide (ITO), Fluorine-doped Tin Oxide (FTO), carbon nanotubes (CNTs) or other similar materials.

6. The system of claim 1, wherein the high reflectivity coating comprises a silver-based coating including either one of Ag2, Ag3, Ag4 or other silver-based compounds.

7. The system of claim 1, wherein the low-emissivity (Low-E) coating is connected with two busbars to measure the electrical resistance changes for detecting surface temperature.

8. The system of claim 1, wherein the higher resistance coating includes ablated tracks to lengthen the distance of current flow for increasing coating resistance.

9. The system of claim 1, wherein an electric charge is applied to the low-emissivity (Low-E) coating and the higher resistance coating to measure impedance changes for proximity detection.

10. The system of claim 9, wherein proximity detection includes dielectric permittivity detection.

11. A method for manufacturing a multi-layered system for deicing and defogging of transparent surfaces, the method comprising:
applying a high reflectivity, low-emissivity (Low-E) coating onto a surface facing the exterior environment, the high reflectivity, low-emissivity (Low-E) coating configured to control solar heat gain; and
applying a higher resistance coating adjacent to the high reflectivity, low-emissivity (Low-E) coating, the higher resistance coating having a resistance higher than the high reflectivity, low-emissivity (Low-E) coating, the higher resistance coating configured to receive electricity for generating heat to facilitate deicing and defogging.

12. The method of claim 11, wherein the higher resistance coating has a resistance between 10 ohms/sq to 60 ohms/sq.

13. The method of claim 11, wherein the high reflectivity coating has a total solar transmission (TTS) between 35% to 50%.

14. The method of claim 11, wherein the high reflectivity coating has a resistance between 0.5 ohms/sq to 5 ohms/sq.

15. The method of claim 11, wherein the higher resistance coating comprises a conductive transparent material selected from the group consisting of Indium Tin Oxide (ITO), Fluorine-doped Tin Oxide (FTO), carbon nanotubes (CNTs) or other similar materials.

16. The method of claim 11, wherein the high reflectivity coating comprises a silver-based coating including either one of Ag2, Ag3, Ag4 or other silver-based compounds.

17. The method of claim 11, further comprising connecting the low-emissivity (Low-E) coating with two busbars to measure the electrical resistance changes for detecting surface temperature.

18. The method of claim 11, further comprising providing ablated tracks to the higher resistance coating to lengthen the distance of current flow for increasing coating resistance.

19. The method of claim 11, further comprising applying an electric charge to the low-emissivity (Low-E) coating and the higher resistance coating to measure impedance changes for proximity detection.

20. The method of claim 19, wherein proximity detection includes dielectric permittivity detection.
